(19) United States
(12) Patent Application Publication
(10) Pub. No.: US 2024/0347783 A1
(43) Pub. Date: Oct. 17, 2024

(54) PHOSPHAZENE DERIVATIVE, COMPOSITION, AND AN ELECTROCHEMICAL DEVICE COMPRISING THE SAME

(71) Applicants: China Petrochemical Development Corporation, Taipei (Taiwan), Kaohsiung City (TW); NATIONAL CHEN KUNG UNIVERSITY, Tainan City (TW)

(72) Inventors: Jeng-Shiung Jan, Tainan City (TW); Jian-Zhou Chen, Kaohsiung City (TW); Chih-Wei Huang, Kaohsiung City (TW); Wei-Ying Li, Kaohsiung City (TW); Chun-Chin Lee, Kaohsiung City (TW)

(21) Appl. No.: 18/631,207

(22) Filed: Apr. 10, 2024

(30) Foreign Application Priority Data
Apr. 14, 2023 (TW) 112114098

(51) Int. Cl. H01M 10/42; C07F 9/659; H01M 10/0525; H01M 10/0567; H01M 50/383

(52) U.S. Cl. CPC H01M 10/4235; C07F 9/659; H01M 10/0525; H01M 10/0567; H01M 50/383; H01M 2300/0025

(57) ABSTRACT

The present disclosure provides a phosphazene derivative, a composition for an electrochemical device and an electrochemical device containing the composition The composition includes an electrolyte, a non-aqueous solvent and an additive. The additive includes a phosphazene derivative of the formula (I), n, R₁ and R₂ are as defined herein:

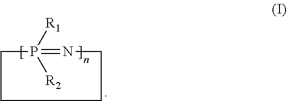

The safety characteristics of the electrochemical device provided in the present disclosure are improved by adding the aforementioned additives to the composition in the electrochemical device.

### REFERENCE TO RELATED APPLICATION

This application claims foreign priority under 35 U.S.C. § 119 (a) to Patent Application No. 112114098, filed on Apr. 14, 2023, in the Intellectual Property Office of Ministry of Economic Affairs, Republic of China (Taiwan, R.O.C.), the entire content of which Patent Application is incorporated herein by reference.

### BACKGROUND

### 1. Technical Field

The present disclosure relates to a composition used in an electrochemical device, especially to a phosphazene derivatives-based additive in the composition applied in the electrochemical device.

### 2. Description of Associated Art

Currently, lithium-ion batteries have been used broadly in the electronic, energy storing, biochemical, electric vehicles, and other devices and equipment. The batteries correspondingly used therefore are expected to have high energy densities and great safeties, as well as the ability to maintain the advantages such as high charge and discharge capacities after long-term usage. Thus, lithium-ion batteries meeting the characteristic requirements are of increasing interest in the associated academics and industries.

Lithium-ion batteries have been used in high power products including electric tools, electric vehicles, and so on, due to their advantages of light mass, high energy density, good cycle properties, high power, and the like. The selection of solid electrolytes, colloidal electrolytes, and fire retardant electrolytes has become a focus of attention for improving the safety of lithium-ion batteries, based on the safety and cost considerations of electric vehicles for a battery as the power source. Although a solid/colloidal electrolyte material can address the risk of electrolyte leakage, it has an issue of the interface resistance still needed to be addressed in various fields and is not a product technique capable of being commercialized in the near future. Therefore, the selection of a suitable fire-retarding electrolyte is one of the options of interest to a manufacturer currently.

A fire-retarding agent containing organic phosphate compounds, triphenyl phosphate (TPP) and tributyl phosphate (TBP), has been described in a literature (Journal of Power Source, Volume 119-121, 1 Jun. 2003, Pages 383-387) and provides excellent thermal safety for a lithium-ion battery in a completely charged state. However, the molecules of most phosphorus-containing compounds have large groups, with an increase in viscosity of the electrolyte in the lithium-ion battery due to excessive addition of phosphorus-containing compounds, which reduces the ion conductivity and has a great side effect on the rate performance of the lithium-ion battery. A highly efficient fire-retarding additive, (ethoxy) pentafluorocyclotriphosphazene (N₃P₃F₅OCH₂CH₃, PFPN), has been described in another literature (Journal of Power Source, Volume 278, 15 Mar. 2015, Pages 190-196) and has been synthesized and used as a safety protective additive in a rechargeable lithium-ion battery. It is believed that the PFPN additive is one of the most efficient fire-retarding additives reported in all literature up to date. The PFPN additive has exhibited good electrochemical compatibility with a graphite anode and a LiCoO₂ cathode, as demonstrated by the charge-discharge test. Meanwhile, the PFPN additive incorporated can improve the cycle performance of the LiCoO₂ electrode at a high voltage cutoff of 4.5 V, suggesting its highly promising application in a high pressure lithium-ion battery.

The PFPN additive, a fluorine-containing phosphazene derivative, has an efficacy better than that of conventional phosphate fire retardants, however, the battery manufacturers show no interest in importing the additive due to the high price. Thus, there is an issue needed to be solved urgently in the art to provide an electrolyte additive with low price, ease of process and ability to improve the safety of a battery.

### SUMMARY

Given the disadvantages of the prior art described above, the present disclosure provides an electrolyte additive with a high electrochemical stability, a low addition amount of additives, and an ability to improve safety of a lithium-ion battery in a good cycle state, without an increase in complexity of process.

For the purpose above, the present disclosure provides a phosphazene derivative having a structure of Formula (I):

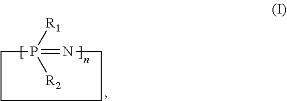

wherein n is an integer of 3 to 6, R₁ and R₂ are independently selected from a group represented by Formula (I-1) or Formula (I-2),

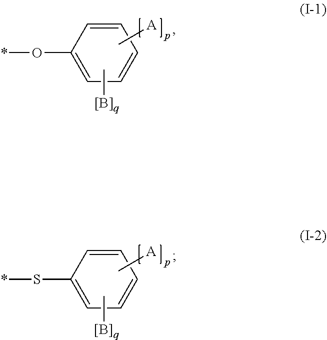

wherein A is —R₃—O—R₄, —R₃—CH₃₋ₘ(OR₄)ₘ, —CH₃₋ₘ(OR₄)ₘ or

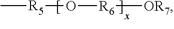

R₃ is unsubstituted C₁-C₈ alkylene or C₁-C₈ alkylene substituted with C₁-C₈ alkyl, R₄ is C₁-C₈ alkyl, R₅ is C₁-C₃ alkyl, R₆ is C₁-C₃ alkylene, R₇ is C₁-C₃ alkyl, x is 1 or 2, m is 2 or 3, p is a number of the A bonded to a carbon in a benzene ring to which the A is attached, and p is an integer of 0 to 3;
B is C₁-C₈ alkoxy or C₁-C₈ alkyl, and q is an integer of 0 to 3; and
0<p+q≤5.

In one embodiment of the phosphazene derivative of the present disclosure, n is 3, and R₁ and R₂ are groups represented by Formula (I-1), A is —R₃13 O—R₄, R₃ is C₁-C₈ alkylene, R₄ is C₁-C₈ alkyl, and p is 0 or 1; B is C₁-C₈ alkoxy, and q is 0 or 1; and 0<p+q≤2.

In one embodiment of the phosphazene derivative of the present disclosure, when the R₁ and R₂ are selected from groups shown in Formula (I-1), the phosphazene derivative is one selected from the group consisting of compounds of (1-1) to (1-4):

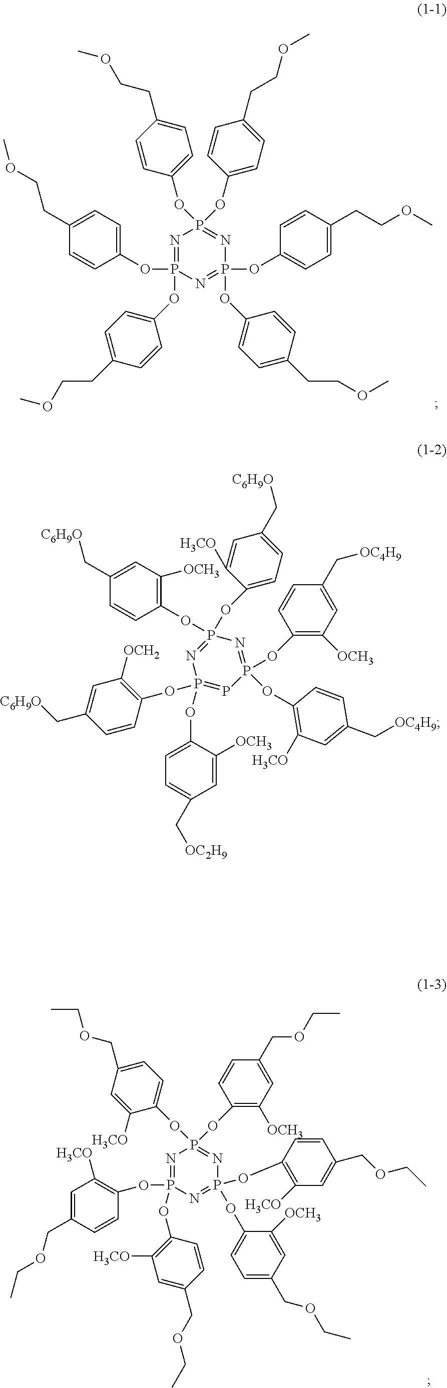

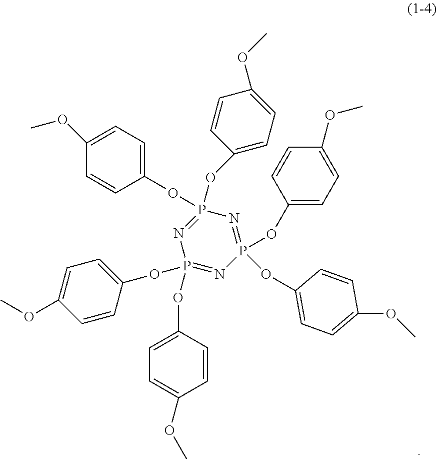

The present disclosure further provides a composition for an electrochemical device, and the composition comprises an electrolyte, a non-aqueous solvent and an additive comprising the phosphazene derivative of the present disclosure.

In one embodiment of the composition of the present disclosure, in the phosphazene derivative having the structure of Formula (I), n is 3, and R₁ and R₂ are groups showed in Formula (I-1), A is —R₃—O—R₄, R₃ is C₁-C₈ alkylene, R₄ is C₁-C₈ alkyl, and p is 0 or 1; B is C₁-C₈ alkoxy, and q is 0 or 1; and 0<p+q≤2.

In one embodiment of the composition of the present disclosure, when the R₁to R₂ are selected from groups showed in Formula (I-1), the phosphazene derivative is one selected from the group consisting of compounds of (1-1) to (1-4):

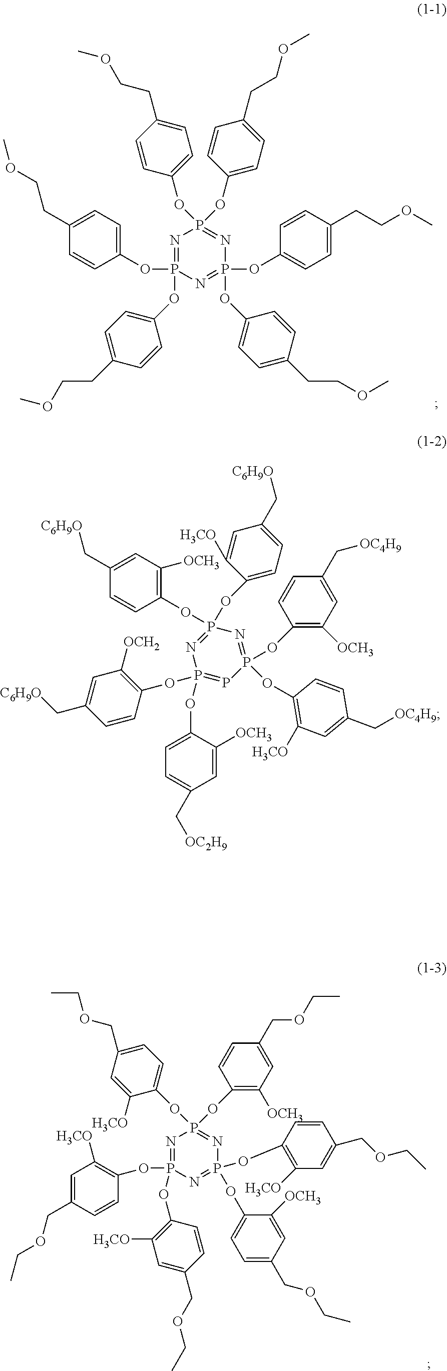

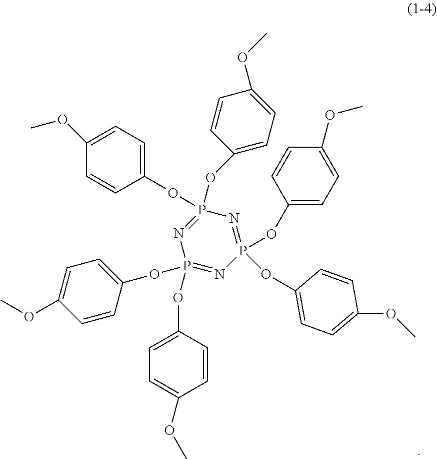

In one embodiment of the composition of the present disclosure, the electrolyte is present at an amount of 9.95 to 19.95 wt. % based on a total weight of the composition.

In one embodiment of the composition of the present disclosure, the additive is present at an amount of 0.05 to 20.0 wt. % based on a total weight of the composition.

In one embodiment of the composition of the present disclosure, the electrolyte comprises at least one selected from lithium hexafluorophosphate (LiPF₆), lithium fluoroborate (LiBF₄), lithium bis (trifluoromethanesulfonyl) imide (LiN (CF₃SO₂)₂), and lithium trifluoromethanesulfonate (LiCF₃SO₃).

In one embodiment of the composition of the present disclosure, the non-aqueous solvent comprises at least one selected from the group consisting of carbonates, furans, ethers, sulfides, and nitriles.

In one embodiment of the composition of the present disclosure, the non-aqueous solvent comprises at least one selected from the group consisting of ether-based polymers, polymethacrylate-based polymers, polyacrylated polymers, and fluoropolymers.

The present disclosure further provides an electrochemical device, comprising an anode, a cathode, and the composition of the present disclosure configured between the anode and the cathode.

In one embodiment of the electrochemical device of the present disclosure, it is a lithium-ion secondary battery.

Accordingly, the composition used in an electrochemical device of the present disclosure comprises a novel phosphazene derivative-based additive, and the defect in the safety of the conventional lithium-ion battery can be improved by the use of the additive.

### BRIEF DESCRIPTION OF THE DRAWINGS

The present disclosure can be more fully understood by reading the following descriptions of the embodiments, with reference made to the accompanying drawings.

FIGS. 1A to 1D are NMR spectra of the compounds of Formulae 1-1 to 1-4 of the present disclosure, respectively.

FIGS. 2A to 2E show results of 1C cycle life tests under an environmental temperature of 25° C. for batteries having the electrolytes without addition of the compound of Formula 1-1 or with addition of the compound of Formula 1-1 at an amount of 5%, 10%, 15% and 20%, respectively.

FIGS. 3A to 3E show results of charge-discharge rate tests under an environmental temperature of 25° C. with different rates of 0.1 C, 0.2 C, 0.3 C, 0.5 C and 1 C for batteries having the electrolyte without addition of the compound of Formula 1-1 or with addition of the compound of Formula 1-1 at an amount of 5%, 10%, 15% and 20%, respectively.

FIGS. 4A to 4B show observation curves of a battery voltage and a temperature in nail penetration tests on NMC622 lithium ion batteries.

### DETAILED DESCRIPTION OF THE PREFERRED EMBODIMENTS

The following examples are used for illustrating the present disclosure. A person skilled in the art can easily conceive the other advantages and effects of the present disclosure, based on the disclosure of the specification. The present disclosure can also be implemented or applied as described in different examples. It is possible to modify or alter the following examples for carrying out this disclosure without contravening its scope, for different aspects and applications.

The present disclosure is directed to a phosphazene derivative having a structure of Formula (I):

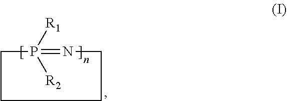

wherein n is an integer of 3 to 6, R₁ and R₂ are independently selected from a group represented by Formula (I-1) or Formula (I-2),

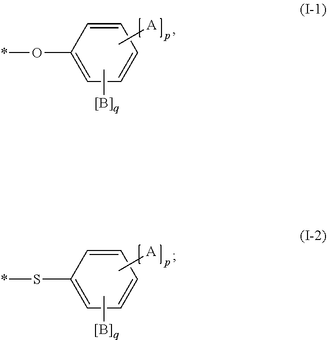

wherein A is —R₃—O—R₄, —R₃—CH₃₋ₘ(OR₄)ₘ, —CH₃₋ₘ(OR₄)ₘ or

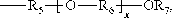

R₃ is unsubstituted C₁-C₈ alkylene or C₁-C₈ alkylene substituted with C₁-C₈ alkyl, R₄ is C₁-C₈ alkyl, R₅ is C₁-C₃ alkyl, R₆ is C₁-C₃ alkylene, R₇ is C₁-C₃ alkyl, x is 1 or 2, m is 2 or 3, p is a number of the A bonded to a carbon in a benzene ring to which the A is attached, and p is an integer of 0 to 3;
B is C₁-C₈ alkoxy or C₁-C₈ alkyl, and q is an integer of 0 to 3; and 0<p+q≤5.

In one embodiment, a range of the number of carbon atoms of the present disclosure can extend from a lower limit to an upper limit, for example, C₁-C₈ refers to a number of the carbon atom(s) of 1, 2, 3, 4, 5, 6, 7, or 8.

In some embodiments, the compound of the phosphazene derivative having the structure of Formula (I) of the present disclosure is selected from Table 1, but not limited thereto.

TABLE 1

| | |
|---|---|
| Compound of Formula 1-1 | 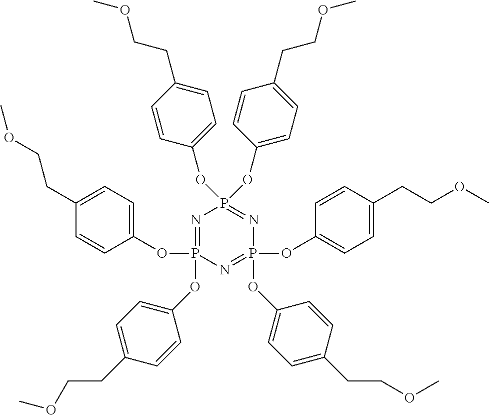 |
| Compound of Formula 1-2 | 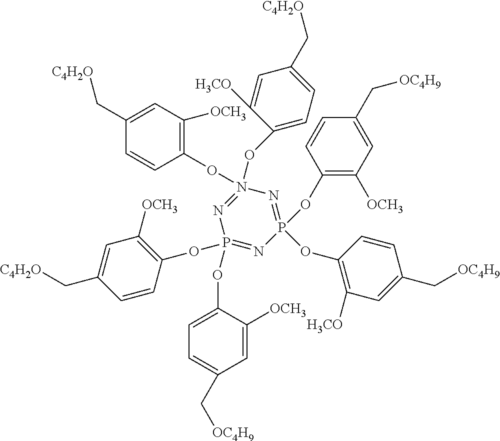 |
| Compound of Formula 1-3 | 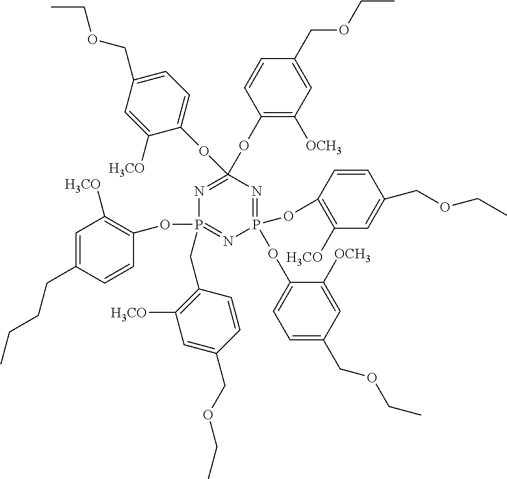 |
| Compound Formula 1-4 | 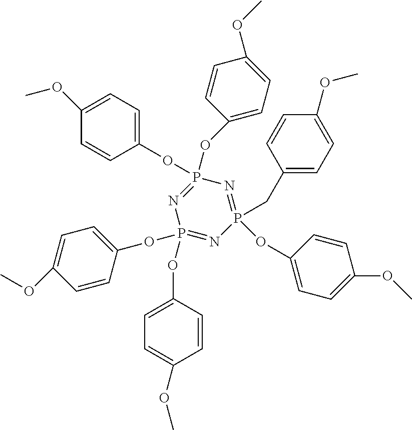 |

In another embodiment, the compound of the phosphazene derivative having the structure of Formula (I) of the present disclosure is preferably the following compound:

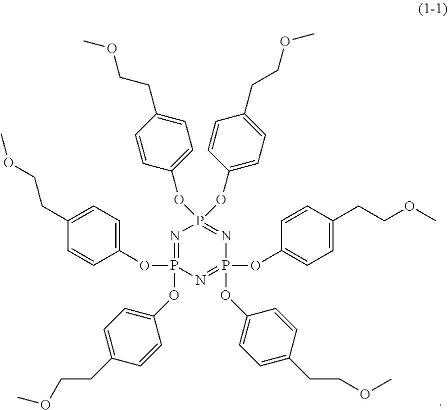

In another embodiment, the present disclosure provides a composition for an electrochemical device, which comprises the novel phosphazene derivative-based additive of the present disclosure. The defect of the electrochemical device of poor safety can be improved by the use of the additive. In one embodiment, the composition of the present disclosure comprises an electrolyte, a non-aqueous solvent and an additive. The additive comprises the phosphazene derivative having the structure of Formula (I) of the present disclosure:

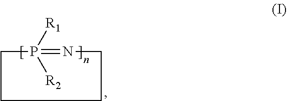

wherein n is an integer of 3 to 6, R₁ and R₂ are independently selected from a group represented by Formula (I-1) or Formula (I-2),

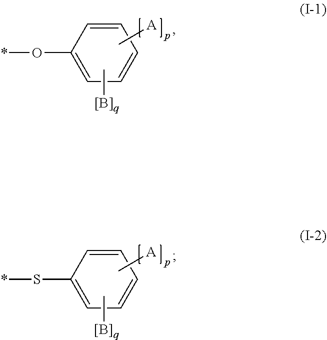

wherein A is —R₃—O—R₄, —R₃—CH₃₋ₘ(OR₄)ₘ, —CH₃₋ₘ(OR₄)ₘ or

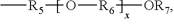

R₃ is unsubstituted C₁-C₈ alkylene or C₁-C₈ alkylene substituted with C₁-C₈ alkyl, R₄ is C₁-C₈ alkyl, R₅ is C₁-C₃ alkyl, R₆ is C₁-C₃ alkylene, R₇ is C₁-C₃ alkyl, x is 1 or 2, m is 2 or 3, p is a number of the A bonded to a carbon in a benzene ring to which the A is attached, and p is an integer of 0 to 3;
B is C₁-C₈ alkoxy or C₁-C₈ alkyl, and q is an integer of 0 to 3; and 0<p+q≤5.

In one embodiment, a range of the number of carbon atoms of the present disclosure can extend from a lower limit to an upper limit, for example, C₁-C₈ refers to a number of carbon atoms of 1, 2, 3, 4, 5, 6, 7, or 8.

In one embodiment, the phosphazene derivative having the structure of Formula (I) contained in the additive of the composition of the present disclosure is selected from Table 1 aforementioned, but not limited thereto.

In another embodiment, the phosphazene derivative having the structure of Formula (I) contained in the additive of the composition of the present disclosure is preferably the following compound:

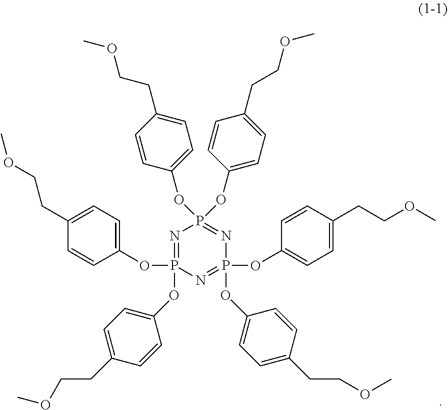

In the composition of the present disclosure, the contents of each component can vary depending on the actual application and is not limited to the contents described herein.

In one embodiment, the amount of the electrolyte contained in the composition of the present application is about 9.95 to 19.95 wt. %, e.g., 9.95, 10.0, 11.0, 12.0, 13.0, 14.0, 15.0, 16.0, 17.0, 18.0, 19.0 or 19.95 wt. %, based on the total weight of the composition.

In one embodiment, the amount of the additive contained in the composition of the present application is about 0.05 to 20.0 wt. %, e.g., 0.05, 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0, 11.0, 12.0, 13.0, 14.0, 15.0, 16.0, 17.0, 18.0, 19.0 or 20.0 wt. %, based on the total weight of the composition.

In the composition of the present disclosure, the content of the non-aqueous solvent can vary corresponding to changes in the contents of other components in the composition, provided that the total amount of the non-aqueous solvent and the other components in the composition is 100 wt. % That is, one of the uses of the non-aqueous solvent is to complement the composition to 100 wt. %. In one embodiment, the non- aqueous solvent contained in the composition of the present disclosure is at an amount of about 65.0 to 90.0 wt. %, e.g., 65, 66, 67, 68, 69, 70, 71, 72, 73, 74, 75, 76, 77, 78, 79, 80, 81, 82, 83, 84, 85, 86, 87, 88, 89 or 90 wt. %. In one embodiment, the composition of the present disclosure contains the non-aqueous solvent at an amount of about 80.0 to 90.0 wt. %.

The electrolytes suitable for the present disclosure are those commonly used in the art. In one embodiment of the composition of the present disclosure, the electrolyte comprises at least one selected from the group consisting of lithium hexafluorophosphate (LiPF₆), lithium fluoroborate (LiBF₄), lithium bis (trifluoromethanesulfonyl) imide (LiN(CF₃SO₂)₂), and lithium trifluoromethanesulfonate (LiCF₃SO₃).

The non-aqueous solvent in the composition of the present disclosure can be in a liquid or non-liquid form such as solid or gel, but not limited thereto.

In one embodiment of the non-aqueous solvents in the liquid form, those commonly used in the art can be selected, such as at least one selected from the group consisting of carbonates (e.g., ethylene carbonate, propylene carbonate, dimethyl carbonate, diethyl carbonate, or methylethyl carbonate), furans (e.g., tetrahydrofuran), ethers (e.g., diethyl ether), sulfides (e.g., methyl-sulfolane) and nitriles (e.g., acetonitrile, propionitrile). In one embodiment of the composition of the present disclosure, the non-aqueous solvent comprises at least one selected from the group consisting of carbonates, furans, ethers, sulfides and nitriles.

In one embodiment, the non-aqueous solvents in the non-liquid form can be a polymer compound, e.g., at least one selected from the group consisting of ether-based polymers (e.g., polyethyleneoxide or a cross-linked product thereof), polymethacrylate- based polymers, polyacrylate-based polymers, fluoropolymers (e.g., polyvinylidene fluoride (PVDF) and vinylidene fluoride-hexafluoro propylene polymer). In one embodiment of the composition of the present disclosure, the non-aqueous solvent comprises at least one selected from the group consisting of ether-based polymers, polymethacrylate-based polymers, polyacrylated polymers, and fluoropolymers.

The composition of the present disclosure can be obtained either by dissolving the aforementioned electrolyte and the phosphazene derivative-based additive of the present disclosure in a liquid non-aqueous solvent described above or by dissolving the electrolyte and the phosphazene derivative-based additive in liquid non-aqueous solvents, respectively, followed by mixing. If the used non-aqueous solvent is solid, the electrolyte, the phosphazene derivative-based additive and the solid non-aqueous solvent are first dissolved with organic solvents (e.g., alkanes, ketones, aldehydes, alcohols, ethers, benzene, toluene, xylene, kerosene, or the combination thereof), mixed thoroughly, and heated to evaporate the organic solvents to yield the composition of the present disclosure.

In another embodiment, the electrochemical device different from the conventional devices is provided by applying the aforementioned composition therein. In other words, the present disclosure also provides an electrochemical device, comprising an anode, a cathode, and the composition of the present disclosure configured between the anode and the cathode.

In one embodiment, the electrochemical device of the present disclosure is a lithium-ion secondary battery.

### EXAMPLES

Various properties and efficacies will be illustrated by Examples below. The Examples set forth are used to illustrate the properties of the present disclosure which is not limited to those illustrated in the particular examples.

### Preparation Example 1

### 1. Preparation of the Compound of Formula 1-1:

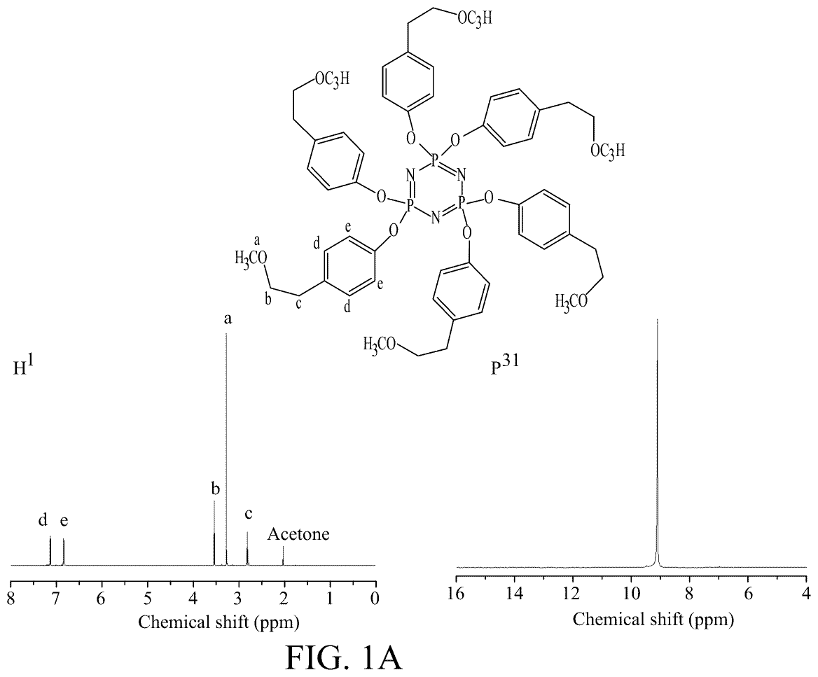

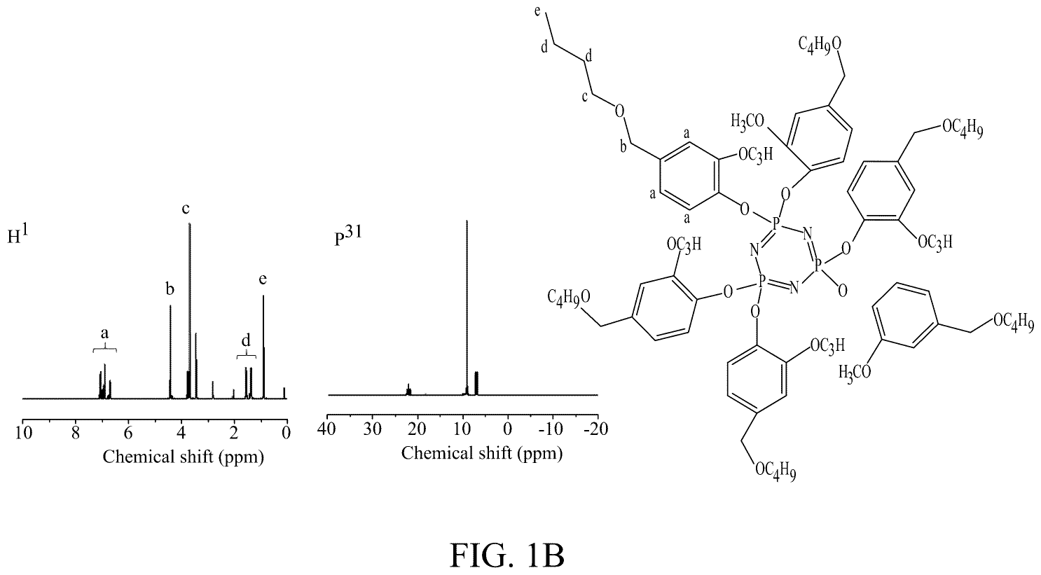

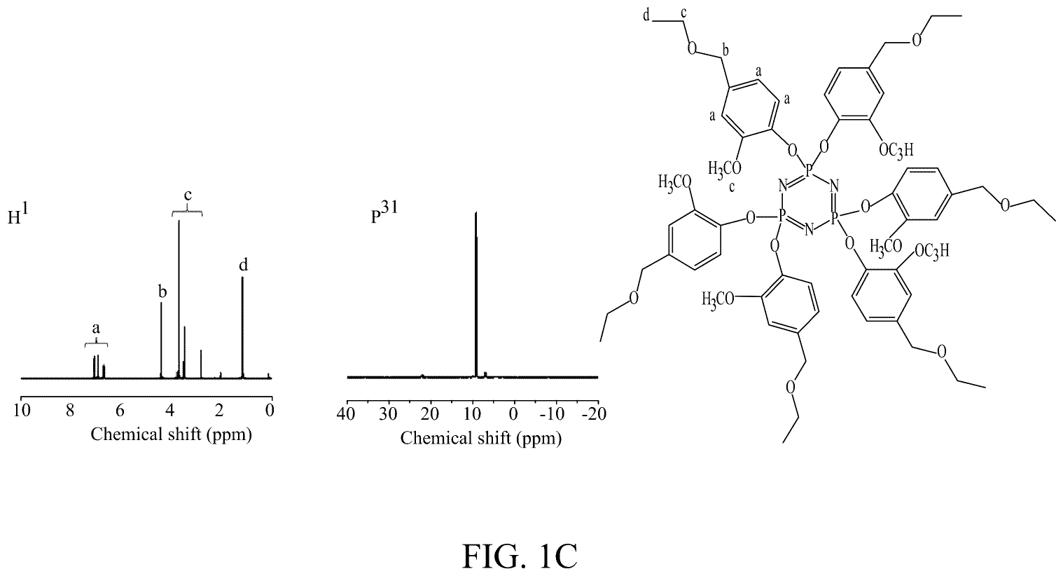

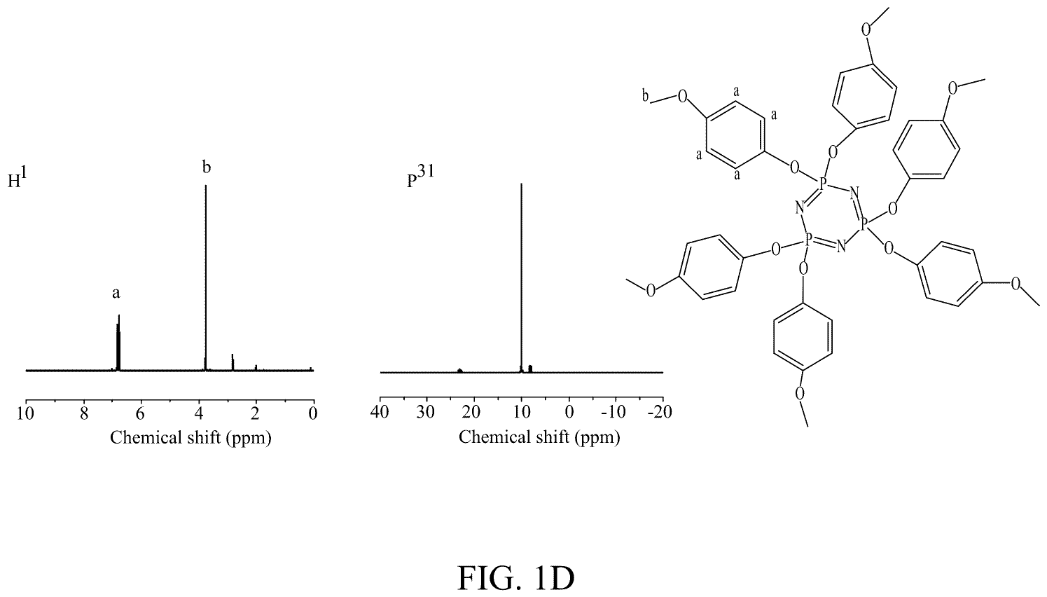

The compound of Formula 1-1 of the present disclosure can be prepared by the following Scheme 1. Specifically, hexachlorophosphazene (1 g, 2.87 mmol, 1 eq) was mixed with acetone (20 mL) to form Solution a; 4-(2-methoxyethyl) phenol (3.94 g, 25.9 mmol, 9 eq) was mixed with acetone (60 mL) to form Solution b. Afterwards, K₂CO₃ (3.58 g, 25.9 mmol, 9 eq) was added to the Solution b to form Solution c. The Solution c was poured into the Solution a to perform a condensation and reflux reaction in an oil bath at 70° C. for 4 days. After the reaction was completed, the solid was removed, and the solvent was removed by distillation under a reduced pressure to yield a crude product. The crude product was washed with methanol and water repeatedly, and then freezing-dried to yield the compound of Formula 1-1 as a powder. The NMR spectrum of the compound of Formula 1-1 was shown in FIG. 1A.

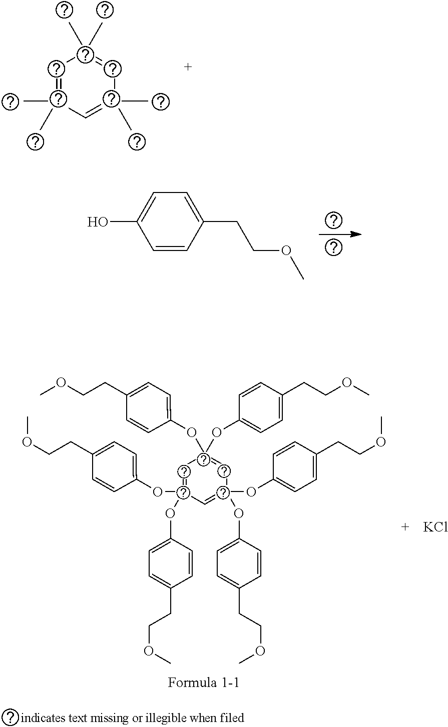

### 2. Preparation of the Composition for the Electrochemical Device

Ethylene carbonate (EC) was dissolved in diethyl carbonate (DEC) or dimethyl carbonate (DMC) at an equal weight ratio, to give a mixed solution of EC:DEC:DMC (1:1:1) or EC:DEC (1:1). Thereafter, 11.8 wt. % of LiPF₆ electrolyte was added to the mixed solution aforementioned, after calculated based on the weight molar concentration. Finally, 5 wt. % or 7 wt. % of the additive (compound of Formula 1-1 prepared by the method described) was added and stirred to mix thoroughly, thereby forming the composition for the electrochemical device.

### Preparation Examples 2-4

### 1. Preparation of the Compounds of Formula 1-2 to Formula 1-4:

The compounds were prepared by the same procedures described in the preparation of the compound of Formula 1-1 in the Preparation Example 1, except that 4-(2-methoxyethyl) phenol is replaced with vanillyl butyl ether, vanillyl ethyl ether and 4-methoxyphenol), respectively, to prepare each compound of Formula 1-2, Formula 1-3, and Formula 1-4. The NMR spectra of the compounds of Formula 1-2 to Formula 1-4 were shown in FIGS. 1B-1D, respectively.

### Example 1: Fire-Retarding Tests on Electrolytes

Fire-retarding tests were performed as below by using the compound of Formula 1-1 obtained in Preparative Example 1 in the electrolyte:
1. The compound of Formula 1-1 and the commercially available fire retardant PFPN (pentafluoroethoxycyclotriphosphazene) were dissolved in the commercially available electrolyte (EC:DEC=1:1; 1M LiPF₆) at the amounts of 0 and 5 wt. %, respectively, to form electrolytes to be tested.
2. 10 ml of each electrolyte to be tested was taken into a 20 ml sample bottle. A fiberglass cloth of 4 cm long and 1 cm wide was soaked completely in the electrolyte for 10 sec, and then was removed and fixed at one end on the tube rack with the binder clip.
3. The fiberglass cloth was brought into contact with a fixed fire source (from a commercial butane lighter) at the non-fixed end opposite to the fixed end for 3 secs, then the fire source was removed, and the combustion phenomenon was observed until the flame completely extinguished and the combustion duration was recorded. The duration was recorded as the time from removal of the fire source to complete extinguishing (self-extinguishing time).

Results of tests: The results of the fire-retarding tests were summarized in Table 2 below. It can be seen from the addition concentrations and the self-extinguishing times, the compound of Formula 1-1 did have the effect of improving the fire-retarding capability of the electrolyte, with the fire-retarding effect at an amount of 5% being better than that of PFPN, a commercially available fire-retardant.

TABLE 2
Results of the fire-retarding tests on electrolytes

| | (wt. %) | |
|---|---|---|
| | 0 | 5 |
| Sample | Self-extinguishing time | |
| Fiberglass cloth | 0 s | — |
| Electrolyte (blank reagent) | 24 s | — |
| Electrolyte + PFPN | — | 29 s |
| Electrolyte + compound of Formula 1-1 | — | 19 s |

### Example 2: Cycle life Tests on LiFePO₄ coin cells

### 1. Battery Assembling:

Coin cells were assembled by using LiFePO₄ as the cathode, lithium as the anode, and a commercial separator (Celgard® 2325) and an electrolyte (1 M LiPF6 in EC/DEC (1:1)).

### 2. 1C Cycle Life Tests:

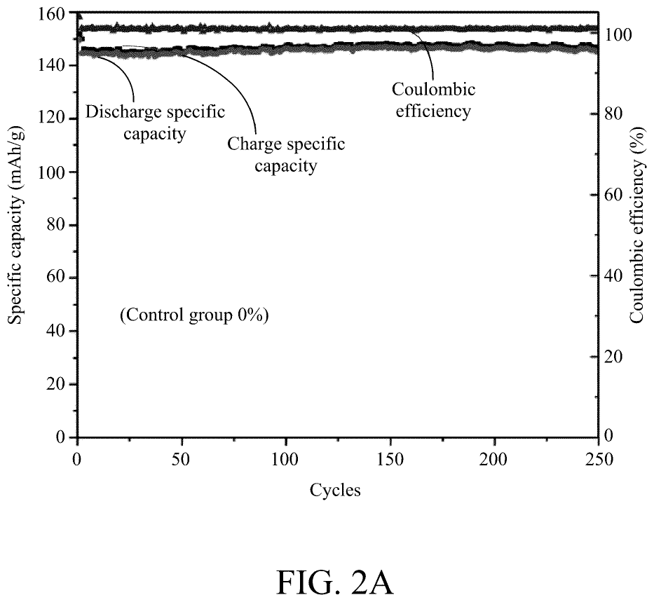

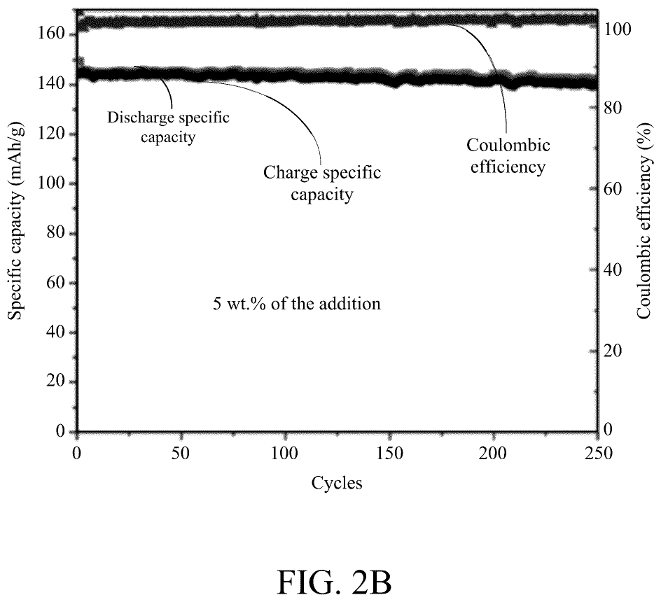

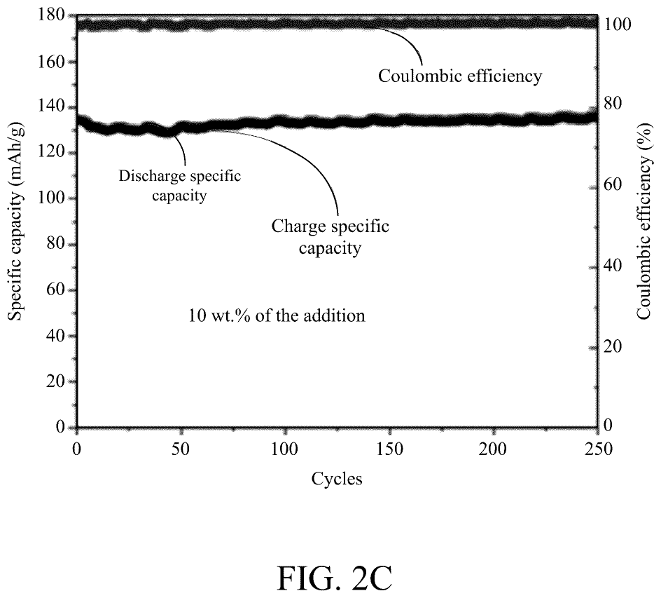

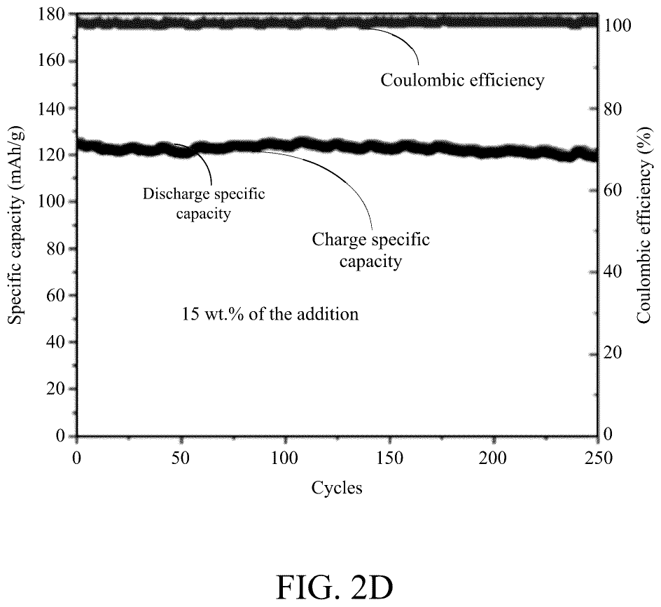

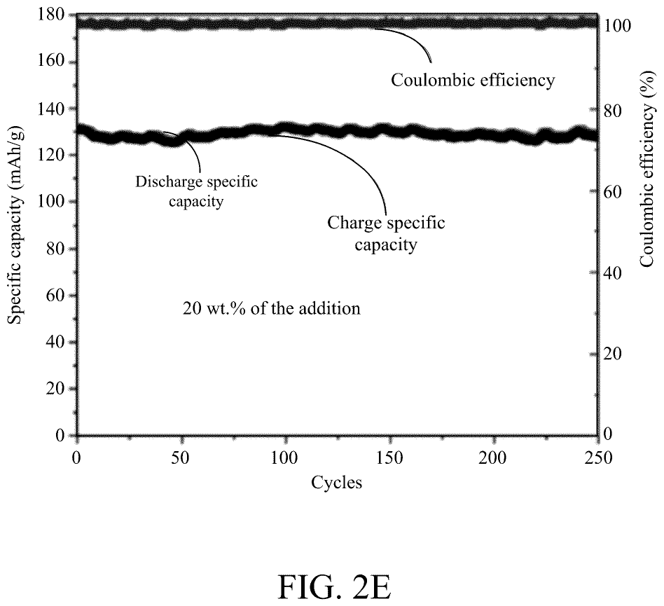

Coin cells were charged and discharged by repeating (1) charging to 4.0V with 1C constant current and (2) discharging to 2.5V under the discharge condition of 1C constant current by using an electrolyte without the addition (0%, as a control group) or with the addition of 5%, 10%, 15% and 20% of the compound of Formula 1-1, under an environmental temperature of 25° C., and the degradation of capacitance in the first 250 cycles was recorded (Charge Discharge Test Instrument: Actech Systems BAT-750B). The results of the tests were shown in FIGS. 2A-2E, it can be seen that neither the addition nor the addition amount of the compound of Formula 1-1 showed an obvious effect on the cycle life of the battery within 250 cycles. Electric capacities during the first 5 cycles and the last 5 cycles as well as the electric capacity retention rates in the 250 cycles tests were recorded in Table 3 below, with different addition ratio of the compound of Formula 1-1.

TABLE 3
Electric capacities during the first/last 5 cycles as well as the electric capacity retention
rates in the 250 cycles tests with different addition ratio of the compound of Formula 1-1

| | Content of the compound of Formula 1-1 (%) | | | | |
|---|---|---|---|---|---|
| | 0 | 5 | 10 | 15 | 20 |
| Electric capacity | 144.6 ± 0.09 | 144.58 ± 0.26 | 133.69 ± 0.64 | 123.89 ± 0.30 | 130.57 ± 0.3 |
| during the first | | | | | |
| 5 cycles (mAh/g) | | | | | |
| Electric capacity | 145.2 ± 0.35 | 139.96 ± 0.24 | 135.42 ± 0.12 | 119.16 ± 0.12 | 128.16 ± 0.11 |
| during the last | | | | | |
| 5 cycles (mAh/g) | | | | | |
| Electric capacity | >100 | 96.8 | >100 | 96.2 | 98.2 |
| retention rate (%) | | | | | |

### Example 3: Charge-Discharge Tests at Different Rates

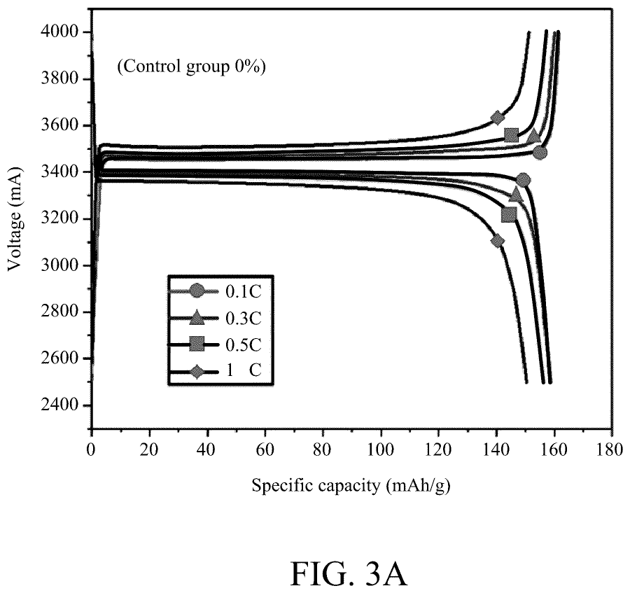

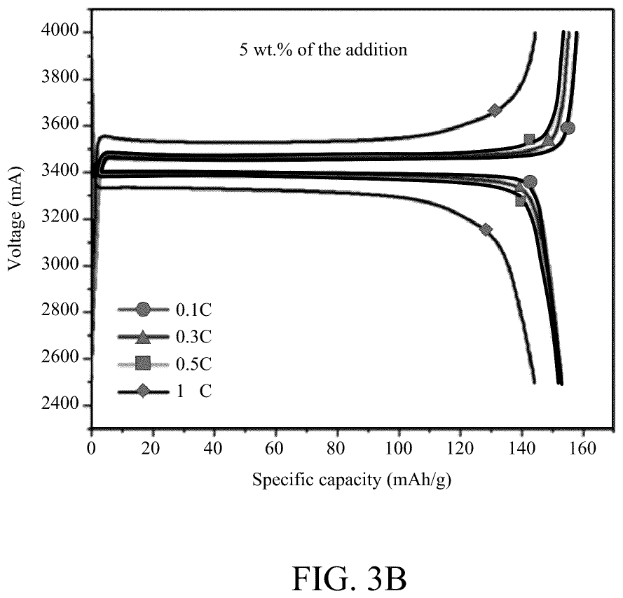

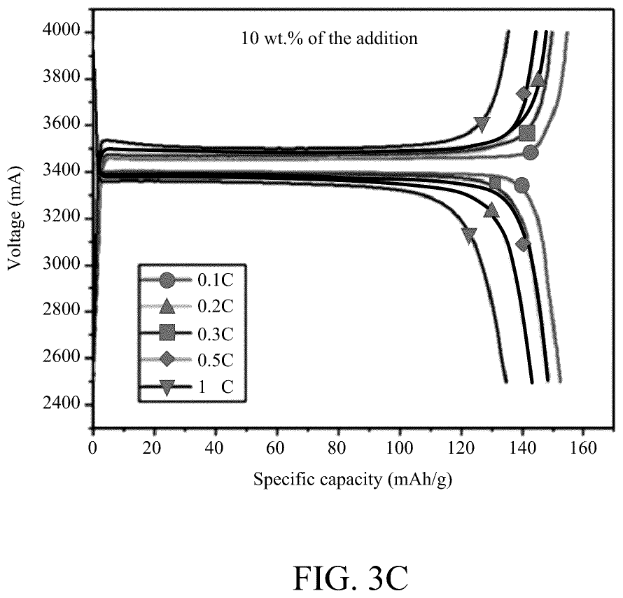

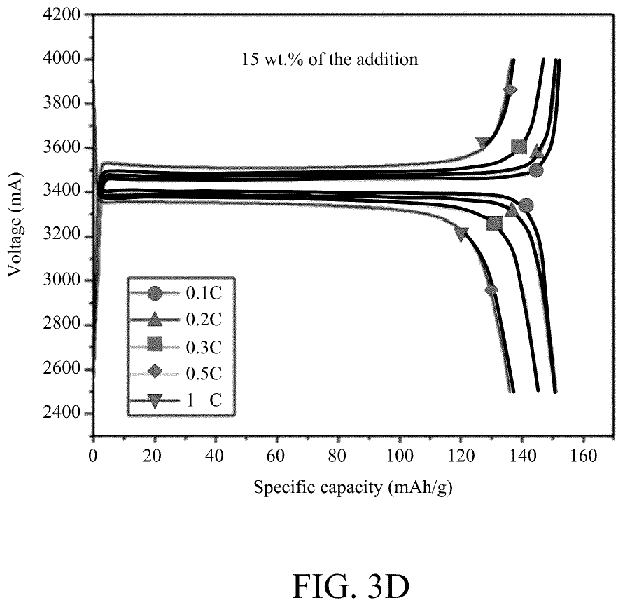

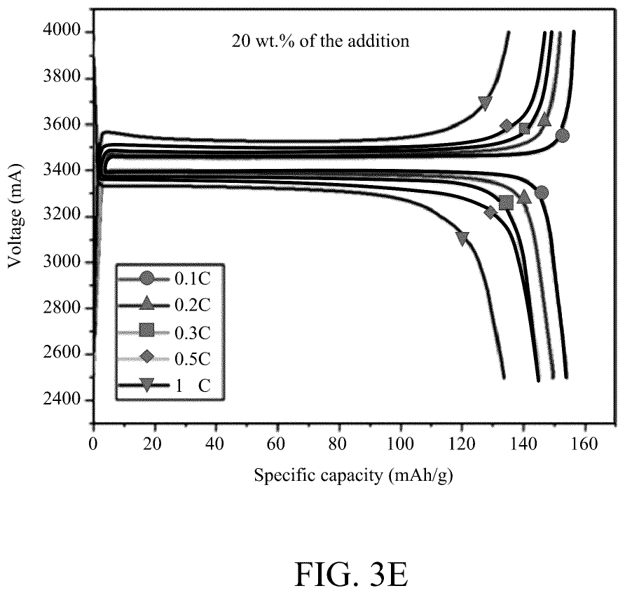

Charge-discharge tests were performed on the coin cells assembled in Example 2 by using an electrolyte without the addition (0%, as the control group) or with the addition of 5%, 10%, 15% and 20% of the compound of Formula 1-1 aforementioned at an environmental temperature of 25° C. with different rates of 0.1 C, 0.2 C, 0.3 C, 0.5 C and 1 C (charge-discharge tester: Acutech Systems BAT-750B). The results of the tests were shown in FIGS. 3A-3E, it can be seen that there was no obvious difference in the specific capacity at the same charge-discharge rate, regardless of the addition and the addition amount of the compound of Formula 1-1. As examples, the discharge specific electric capacities at the rates of 0.1 C and 1 C with different addition amount of the compound of Formula 1-1 were recorded in Table 4 below.

TABLE 4
Discharge specific electric capacities at the rates of 0.1 C and 1
C with different addition amounts of the compound of Formula 1-1

Discharge specific capacity (mAh/g)

| Sample | wt. % | 0.1 C | 1 C |
|---|---|---|---|
| Compound of | 0 | 151.5 | 143.0 |
| Formula 1-1 | 5 | 152.8 | 144.3 |
| | 10 | 152.4 | 134.8 |
| | 15 | 151.2 | 136.8 |
| | 20 | 154.1 | 133.6 |

### Example 4: Performance Tests and nail penetration tests on NMC622 lithium ion batteries

The type of batteries in the tests are punch cells employed with the cathode of LiNi_{0.6}Mn_{0.2}Co_{0.2}O₂ and the anode of artificial graphite (simplified as NMC622 lithium ion batteries), which were designed as shown in Table 5 below.

TABLE 5
Designs of NMC622 lithium ion batteries

| | |
|---|---|
| Anode/cathode | Ni—Mn—Co 622 cathode/ |
| material | artificial graphite anode |
| Compositions | 1M LiPF₆ in electrolyte |
| of electrolyte | (EC:DEC:DMC = 1:1:1) |
| Separator | PP 20 um, without coating |
| Battery size | 3.5 ± 0.1 mm * 40 ± 1 mm * 60 ± 1 mm |
| Battery capacity | 1 Ah (energy density of about 220 Wh/kg |

A punch cell with the addition of 7 wt. % of the compound of Formula 1-1 as the experiment group, and one with no addition of a fire retardant as the control group, were tested for battery performances with a charger/discharger (CT-4008T-5V6A-S1, Neware Technology Co,. Ltd.) (Assayer: Keysight 34972A LXI) and subjected to nail penetration tests. The device for the nail penetration tests was customized by disposing of steel needles and the controller in the metal case and providing temperature and voltage monitors outside the case, with the sensing wiring inserted into the device. The nail penetration tests complied with the specifications for needle diameter and nail penetrating rate in standards such as IEC60086-4:2000, UL1642-2007, and UL2054. Cells were test for performance in steps shown in Table 6 below; and the parameters for nail penetration tests were shown in Table 7 below.

TABLE 6
Steps for testing performance of batteries

| | |
|---|---|
| 1 | Charging to 4.25 V with 1 C constant current |
| 2 | Charging with 1 C constant voltage to a current cutoff of 0.175 A |
| 3 | Resting for 2 minutes |
| 4 | Discharging to 2.8 V with 1 C constant current |
| 5 | Resting for 2 minutes and repeating the steps aforementioned |

TABLE 7
Parameters for nail penetration test

| | | |
|---|---|---|
| Needle diameter | 3 | mm |
| Nail penetrating rate | 4.2 | cm/s |
| Initial height | 24.5 | cm |

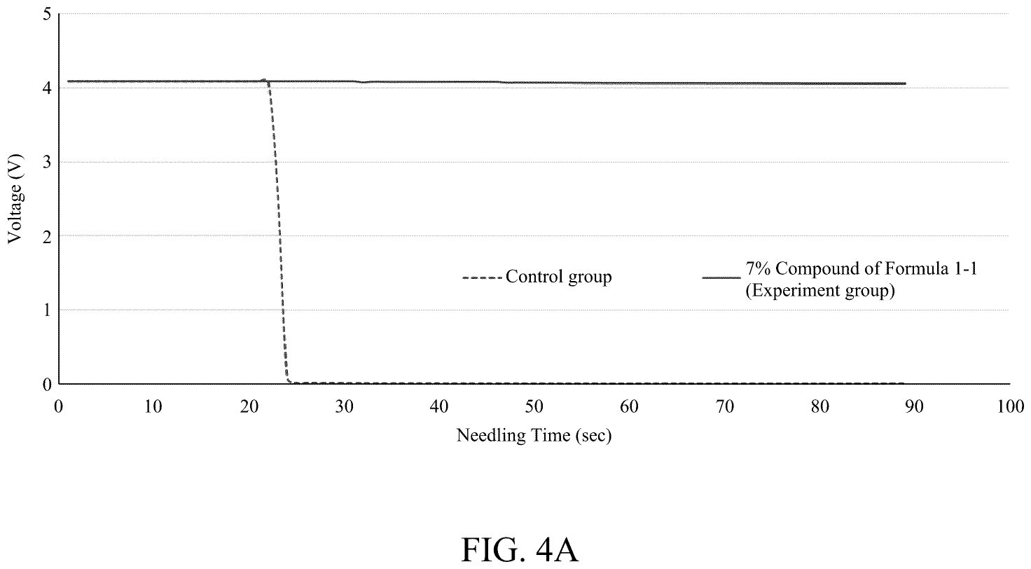

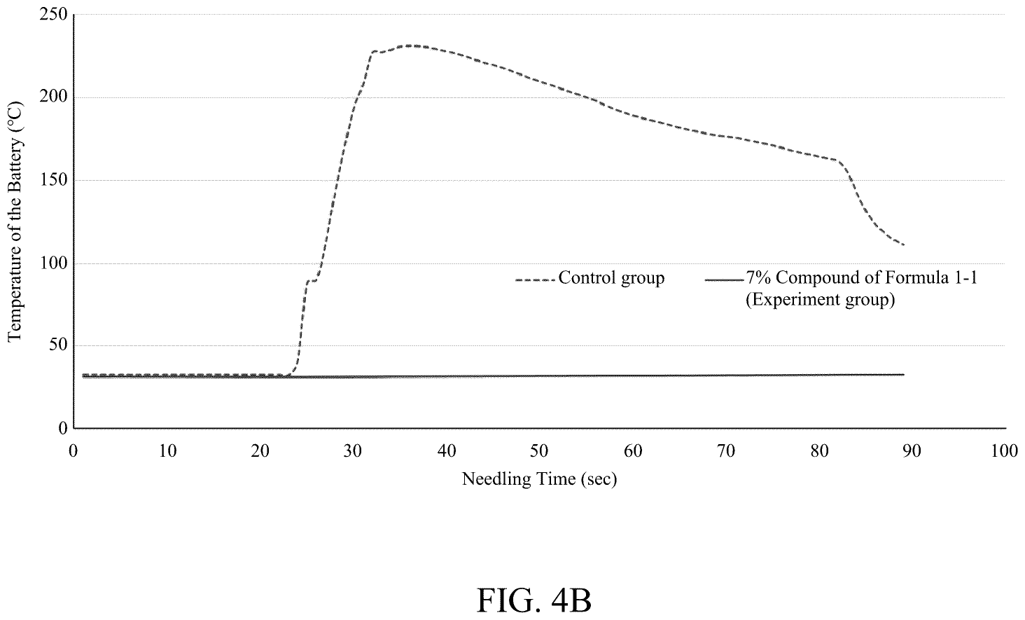

The results from the battery performance test and the nail penetration test were shown in Table 8 below and FIGS. 4A and 4B. It was observed in the nail penetration test, for cells in the experiment group with the addition of the compound of Formula 1-1, no fire or smoke was seen, the surface temperature was maintained at 30° C. without evident increase, and there was no significant change in voltage of the cells; in contrast, fire and smoke were observed in the control group without the addition of any additive with a dramatic increase in surface temperature and reduction in the voltage to 0V. Changes in voltage and temperature of the experiment and control groups were shown in FIGS. 4A and 4B. It can be seen from the results presented above, the safety of battery containing the electrolyte formulated with the compound of Formula 1-1 of the present disclosure was improved in view of the results from the nail penetration test for battery safety relative to those containing the electrolyte without any additive.

TABLE 8
The electronic properties of 1Ah punch cells and the results of nail penetration

| | | | | | Inner | |
|---|---|---|---|---|---|---|
| | | Charging | Median | Factional | resistance | |
| | Additive | voltage | voltage | capacity | of product | Results of nail |
| | (%) | (V) | (V) | (mAh) | (mΩ) | penetration |
| Control | — | 4.25 | 3.64 | 1100.9 | 22.4 | Dramatic rise |
| group | | | | | | in temperature, |
| | | | | | | firing, burning, |
| | | | | | | dropping to |
| | | | | | | zero in voltage |
| Experiment | 7 wt. % of | 4.25 | 3.64 | 1104.4 | 25.7 | No observation |
| group | the compound | | | | | of burning, |
| | of Formula | | | | | no significant |
| | 1-1 | | | | | changes in |
| | | | | | | temperature, |
| | | | | | | voltage, |
| | | | | | | appearance |

It can be seen from the examples above, by using the phosphazene derivative of the present disclosure as the additive to the electrolyte of a lithium-ion battery, in addition to no significant effect on the performance of the battery, the fire retardance effect better than PFPN, a commercially available fire retardant, can be achieved, and the safety of the battery upon external damages can be significantly enhanced. Therefore, the phosphazene derivative of the present disclosure is an inventive substance having excellent efficacies and can be utilized broadly.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the scope of the present disclosure as set forth in the appended claims.

What is claimed is:

1. A phosphazene derivative having a structure of Formula (I): 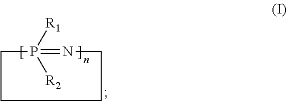
wherein n is an integer of 3 to 6, R₁ and R₂ are independently selected from a group represented by Formula (I-1) or Formula (I-2), 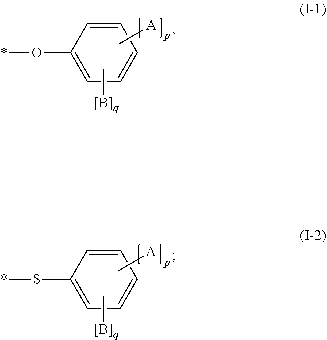
wherein A is —R₃—O—R₄, —R₃—CH₃₋ₘ(OR₄)ₘ, —CH₃₋ₘ(OR₄)ₘ or 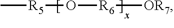
wherein R₃ is unsubstituted C₁-C₈ alkylene or C₁-C₈ alkylene substituted with C₁-C₈ alkyl, R₃is C₁-C₈ alkyl, R₅ is C₁-C₃ alkyl, R₆ is C₁-C₃ alkylene, R₇ is C₁-C₃ alkyl, x is 1 or 2, m is 2 or 3, p is a number of the A bonded to a carbon in a benzene ring to which the A is attached, and p is an integer of 0 to 3;
B is C₁-C₈ alkoxy or C₁-C₈ alkyl, and q is an integer of 0 to 3; and
0<p+q≤5.

2. The phosphazene derivative of claim 1, wherein R₁ and R₂ are groups represented by Formula (I-1), A is —R₃—O—R₄, R₃ is C₁-C₈ alkylene, R₄ is C₁-C₈ alkyl, and p is 0 or 1; B is C₁-C₈ alkoxy, and q is 0 or 1; and 0<p+q≤2.

3. The phosphazene derivative of claim 2, which is one selected from the group consisting of compounds (1-1) to (1-4) below:

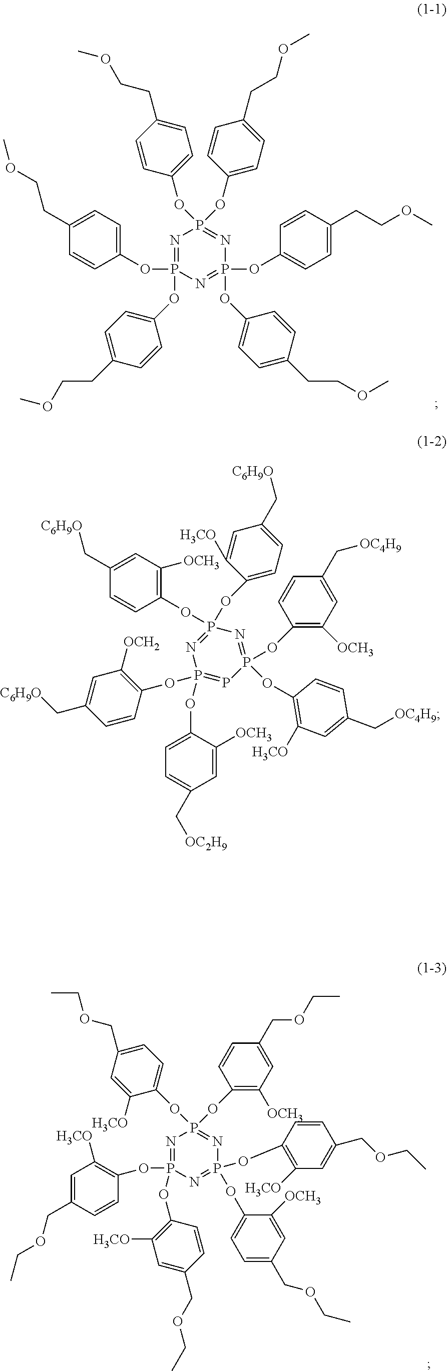

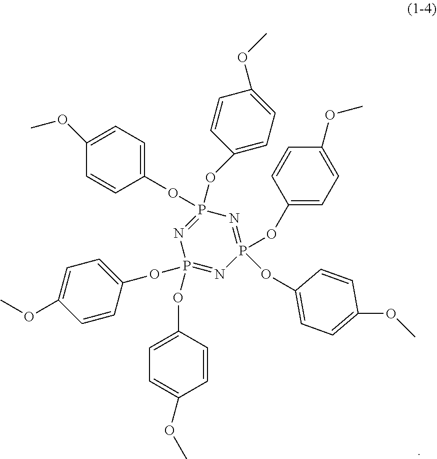

4. A composition for an electrochemical device, comprising an electrolyte, a non-aqueous solvent and an additive, wherein the additive comprises the phosphazene derivative according to claim 1.

5. The composition of claim 4, wherein R₁ and R₂ are groups represented by Formula (1-1), A is —R₃—O—R₄, R₃ is C₁-C₈ alkylene, R₄ is C₁-C₈ alkyl, and p is 0 or 1; B is C₁-C₈ alkoxy, and q is 0 or 1; and 0<p+q≤2.

6. The composition of claim 5, which is one selected from the group consisting of compounds (1-1) to (1-4) below:

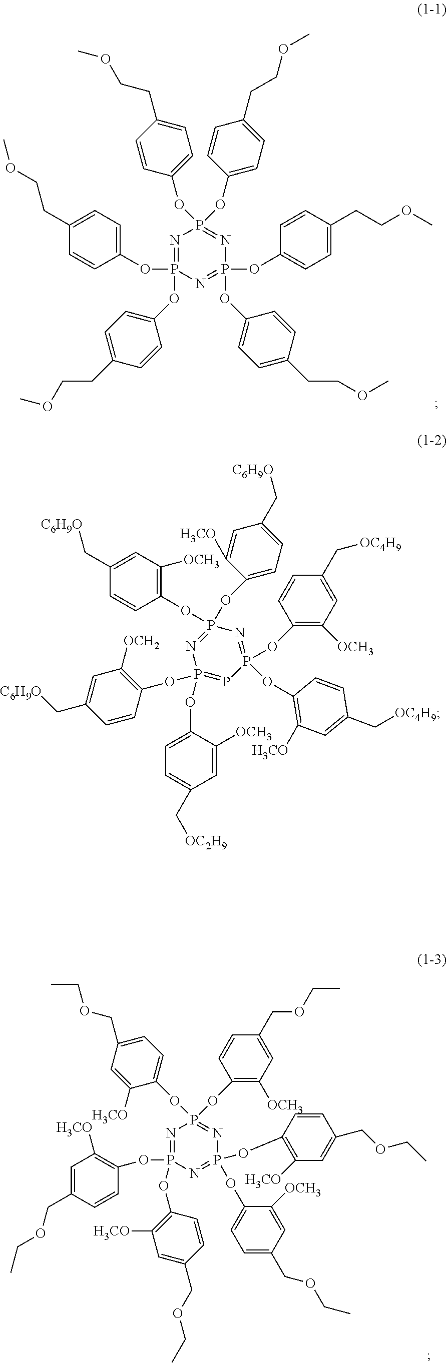

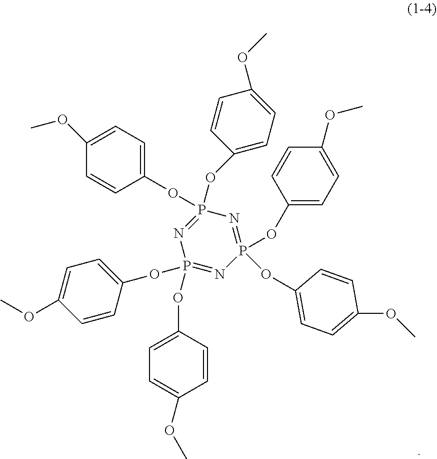

7. The composition of claim 4, wherein the electrolyte is present at an amount of 9.95 to 19.95 wt. %, based on a total weight of the composition.

8. The composition of claim 4, wherein the additive is present at an amount of 0.05 to 20.0 wt. %, based on a total weight of the composition.

9. The composition of claim 4, wherein the electrolyte comprises at least one selected from the group consisting of lithium hexafluorophosphate (LiPF₆), lithium fluoroborate (LiBF₄), lithium bis (trifluoromethanesulfonyl) imide (LiN (CF₃SO₂)₂), and lithium trifluoromethanesulfonate (LiCF₃SO₃).

10. The composition of claim 4, wherein the non-aqueous solvent comprises at least one selected from the group consisting of carbonates, furans, ethers, sulfides, and nitriles.

11. The composition of claim 4, wherein the non-aqueous solvent comprises at least one selected from the group consisting of ether-based polymers, polymethacrylate-based polymers, polyacrylated polymers, and fluoropolymers.

12. An electrochemical device, comprising an anode, a cathode, and the composition of claim 4 configured between the anode and the cathode.

13. The electrochemical device of claim 12, which is a lithium-ion secondary battery.
